(19) United States
(12) Patent Application Publication
(10) Pub. No.: US 2008/0288289 A1
(43) Pub. Date: Nov. 20, 2008

(54) METHOD AND SYSTEM FOR EFFICIENT ORTHODONTIC TREATMENT INFORMATION MANAGEMENT

(75) Inventor: Akash Sah, San Jose, CA (US)

Correspondence Address: JACKSON & CO., LLP, 6114 LA SALLE AVENUE, #507, OAKLAND, CA, 94611-2802, US

(73) Assignee: Align Technology, Inc., Santa Clara, CA (US)

(21) Appl. No.: 11/748,385

(22) Filed: May 14, 2007

(51) Int. Cl. G06F 19/00

(52) U.S. Cl. 705/3; 433/229

(57) ABSTRACT

Method and system for providing generating an orthodontic treatment data package, generating a patient identifier associated with the orthodontic treatment data package, transmitting the generated orthodontic treatment data package to a remote site, encoding the patient identifier and disposing the encoded patient identifier on a housing of an orthodontic treatment container are provided.

### FIELD OF THE INVENTION

The present invention is related generally to the field of orthodontics. More specifically, the present invention is related to methods and system for providing efficient orthodontic treatment information management.

### BACKGROUND

Orthodontic treatments involve repositioning misaligned teeth and improving bite configurations for improved cosmetic appearance and dental function. Repositioning teeth is accomplished by applying controlled forces to the teeth over an extended period of time. This is conventionally accomplished by wearing what are commonly referred to as “braces”. Braces include a variety of appliances such as brackets, bands, archwires, ligatures, and O-rings. After braces are bonded to the teeth, periodic meetings with an orthodontist are typically required to adjust the braces. This may involve replacing or tightening existing ligatures. Between meetings, patients may be required to wear supplementary appliances, such as elastic bands, or headgear, to supply additional or extraoral forces.

Additionally, there is another approach that relies upon the use of elastic positioning appliances for realigning teeth. Such appliances comprise a thin shell of elastic material that generally conforms to the patient's teeth, but that is slightly out of alignment with the patient's initial tooth configuration. Placement of the elastic positioner over the teeth applies controlled forces in specific locations to gradually move the teeth into the new configuration.

In this approach, the patient is provided with a series of dental appliances whose cavity geometry differs incrementally. Given this, to execute a dental treatment plan, the patient is typically provided with a predetermined number of dental appliances, and may be instructed to use certain one of the predetermined number of dental appliances over the course of the treatment time period. To manufacture each one of the dental appliances for a given treatment plan, generally, the manufacturing site or location for the dental appliances receives patient's initial condition information such as, for example, bite registration or dental impression in a shipping container. Upon receipt at the manufacturing site or location of the bite registration and/or dental impression and any other information associated with the patient's orthodontic treatment plan, the associated data or information is scanned or otherwise generated based on the physical treatment material received within the container housing. This is generally time consuming and labor intensive.

In view of the foregoing, it would be desirable to have methods and systems for providing efficient orthodontic treatment information management.

### SUMMARY OF THE INVENTION

In view of the foregoing, in accordance with the various embodiments of the present invention, there are provided methods and system for generating an orthodontic treatment data package, generating a patient identifier associated with the orthodontic treatment data package, transmitting the generated orthodontic treatment data package to a remote site, encoding the patient identifier, and disposing the encoded patient identifier on a housing of an orthodontic treatment container.

These and other features and advantages of the present invention will be understood upon consideration of the following detailed description of the invention and the accompanying drawings.

### BRIEF DESCRIPTION OF THE DRAWINGS

FIG. 1 is a block diagram of the overall system for practicing the various embodiments of the present invention;

FIG. 2 is a block diagram illustrating the treatment material container housing in accordance with one embodiment of the present invention;

FIG. 3 is a flowchart illustrating efficient orthodontic treatment information management in accordance with one embodiment of the present invention;

FIG. 4 is a flowchart illustrating efficient orthodontic treatment information management in accordance with another embodiment of the present invention; and

FIG. 5 is a flowchart illustrating efficient orthodontic treatment information management in accordance with yet another embodiment of the present invention.

### DETAILED DESCRIPTION

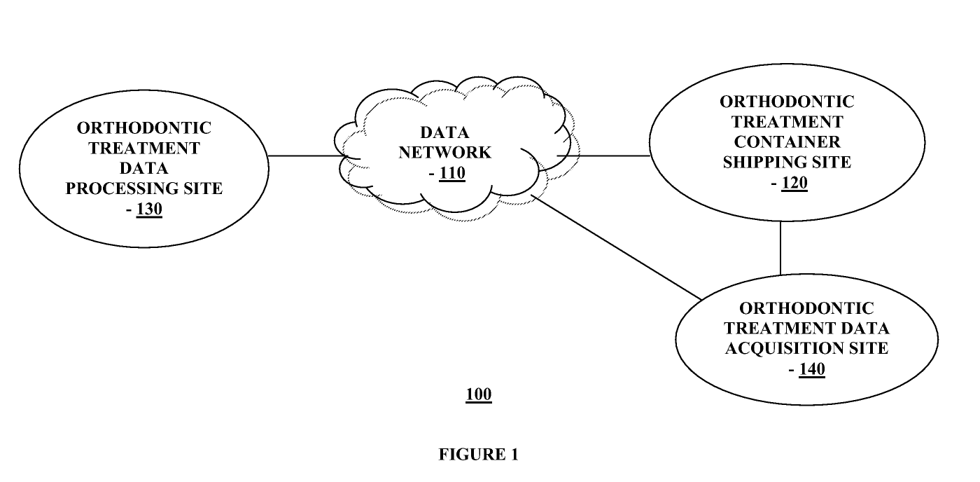

FIG. 1 is a block diagram of the overall orthodontic treatment information management system 100 for practicing the various embodiments of the present invention. The orthodontic treatment information management system 100 in one embodiment includes an orthodontic treatment data acquisition site 140 such as an orthodontist's office, hospital or clinic, or any other suitable location where orthodontic data or information may be acquired. Also provided in the orthodontic treatment information management system 100 is an optional orthodontic treatment container shipping site 120 which is operatively coupled to the orthodontic data acquisition site 140 for, among others, data communication and transfer of orthodontic treatment related information for one or more patients, and which may be further configured to provide transportation or shipping services for the treatment related materials such as, but not limited to, dental impressions of a patient, bit registration of a patient, a treatment form, or one or more orthodontic image related information (for example, X-rays and the like).

Referring to FIG. 1, in one embodiment of the present invention, the orthodontic treatment data acquisition site 140 may be configured to also provide the transportation or shipping services for the treatment related materials and/or information. As further shown in FIG. 1, each of the orthodontic treatment data acquisition site 140 and the orthodontic treatment container shipping site 120 is further operatively coupled to a data network 110 for bi-directional data communication therewith. In one aspect, the orthodontic treatment data acquisition site 140 and the orthodontic treatment container shipping site 120 may be configured to communicate or transfer data or information via the data network 110, rather than a direct communication therebetween. In one aspect, the orthodontic treatment container shipping site 120 may include, for example, typical shipping location such as US postal service, mail courier stations such as DHL, UPS and the like.

Referring again to FIG. 1, there is also shown an orthodontic treatment data processing site 130 operatively coupled for data communication with the data network 110. In one embodiment, the orthodontic treatment data processing site 130 includes one or more orthodontic treatment processing plants, locations or sites including, for example, manufacturing sites for the manufacturing of one or more dental appliances such as aligners, retainers, braces and the like.

As described in further detail below, in one embodiment, the orthodontic treatment information management system 100 may be configured to efficiently transmit or distribute treatment related patient information from the treatment data acquisition site 140 to the treatment data processing site 130, for example, by encoding some of all of the patient treatment related information on a treatment material shipping container housing so that, in addition to the actual treatment related material such as bite registration or the dental impressions or the X-rays of the patient's dental conditions, the patient information such as patient identification encoded (and optionally encrypted) on the housing container may be provided. In one embodiment, the encoded information may be provided in the form of one or more of a bar code, a radio frequency identification (RFID). an optical identifier, or any other suitable data encoding mechanism provided on one or more labels, for example, on the treatment material housing container. In this manner, at the treatment data processing site 130 the patient treatment related information may be readily and easily determined or picked up by, for example, a simple scan of the bar code on the shipping container outer housing that has the bar code with the encoded patient treatment information disposed thereon.

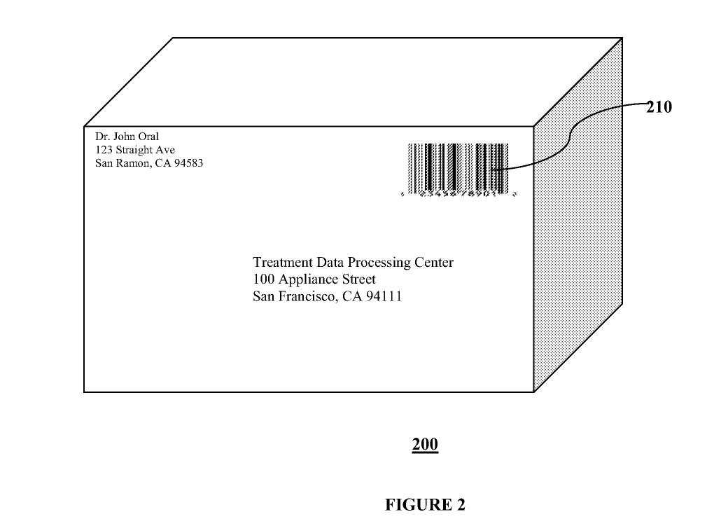

FIG. 2 is a block diagram illustrating the treatment material container housing in accordance with one embodiment of the present invention. Referring to FIG. 2, the treatment material container housing 200 in one embodiment is provided with a shipping label on one outer surface of the container housing 200. Also shown in FIG. 2 is a data encoded area 210 disposed on the outer surface of the container housing 200. In one embodiment, a bar code is shown in the data encoded area 210, where the bar code includes, for example, encoded patient identifier information, among others. Moreover, while a bar code is shown in the data encoded area 210, within the scope of the present invention, other approaches for disposing encoded patient identifier information as well as other patient orthodontic treatment related information may be used such as, for example, radio frequency identification (RFID) tag or chip, an optical identifier, and the like.

In one aspect of the present invention, the treatment material container housing 200 may be prepared and transported at the orthodontic treatment container shipping site 120 (FIG. 1) or at the orthodontic treatment data acquisition site 140 (FIG. 1). In one embodiment, the container housing 200 may be configured to contain or house one or more of a patient's bite registration, dental impression, treatment form, one or more dental images or scans, X-rays of dental conditions, and the like.

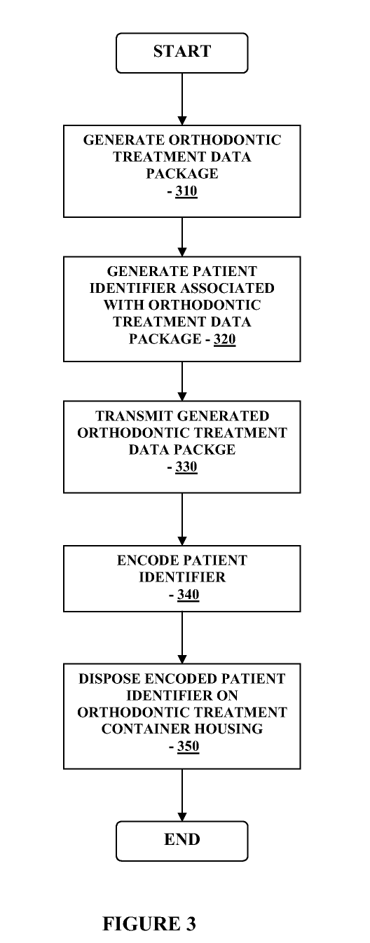

FIG. 3 is a flowchart illustrating efficient orthodontic treatment information management in accordance with one embodiment of the present invention. Referring to FIG. 3, at step 310, orthodontic treatment data package is generated. In one aspect, the orthodontic treatment data package may include, for example, an orthodontic treatment plan information, a treatment form, one or more orthodontic image related information, one or more dental impression information, or one or more bite registration information. Some or all of the treatment data package may be encrypted at, for example, the data acquisition site 140 to be decrypted at the data processing site 130. Encryption and decryption may use secure socket layer (SSL) encryption or any other suitable data encryption.

Referring back to FIG. 3, after generating the orthodontic treatment data package at step 310, the patient identifier associated with the orthodontic treatment data package is generated at step 320. In one embodiment, the patient identifier may be used to uniquely identify the patient associated with the orthodontic treatment data package. Thereafter, at step 330, the generated orthodontic treatment data package is transmitted over a communication link such as the data network 110 (FIG. 1), for example, from the data acquisition site 140 such as a doctor's office to the data processing site, such as a dental appliance manufacturing location.

Referring yet again to FIG. 3, after transmitting the generated orthodontic treatment data package at step 330, the patient identifier is encoded at step 340, and disposed on the orthodontic treatment container housing at step 350. That is, the encoded patient identifier may be in one embodiment disposed on the container housing 200 (FIG. 2) which is configured to house other treatment related material and that is packaged for shipping or transportation to the dental appliance manufacturing facility.

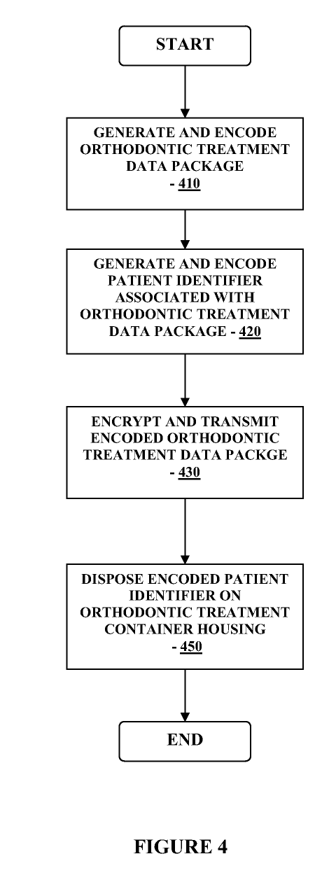

FIG. 4 is a flowchart illustrating efficient orthodontic treatment information management in accordance with another embodiment of the present invention. Referring to FIG. 4, at step 410, orthodontic treatment data package is generated and encoded. Thereafter at step 420, patient identifier associated with the orthodontic treatment data package is generated and encoded. Then, at step 420, the encoded orthodontic treatment data package is encrypted and transmitted over a data network 110 (FIG. 1), for example, to an orthodontic treatment data processing site 130. Additionally, at step 450, the encoded patient identifier is disposed on the orthodontic treatment container housing. For example, in one aspect, the encoded patient identifier may be provided on an exterior surface of the shipping container for the orthodontic treatment related material in the form of bar code label, and RFID tag, an optical identifier, or the like.

In this manner, within the scope of the present invention, the patient orthodontic treatment information including data and material may be efficiently processed and transmitted or transported to the orthodontic treatment data processing site 130. In one embodiment, referring also back to FIG. 1, the orthodontic treatment data acquisition site 140 may include, for example, a personal computer, workstation, or mainframe, with a user interface input device and a user interface output device, and a storage unit such as random access memory (RAM), read only memory (ROM), or any other suitable data storage devices. In addition, the user interface input device may include a keyboard and may further include a pointing devices and/or a scanner, including x-ray or intra-oral scanner. The pointing device may be an indirect pointing device such as a mouse, trackball, touchpad, or graphics tablet, or a direct pointing device such as a touchscreen incorporated into the user interface output device. Other types of user interface input devices, such as voice recognition systems, may be used within the scope of the present invention.

In addition, within the scope of the present invention, the user interface output device may include a printer and a display subsystem, which includes a display controller and a display device coupled to the controller. The display device may be a cathode ray tube (CRT), a flat-panel device such as a liquid crystal display, or a projection device. The display subsystem may also provide nonvisual display such as audio output.

The orthodontic treatment data acquisition site 150 shown in FIG. 1 may also include a data storage unit which is configured to, under the access and control of a control processing device or a client application, to maintain the basic programming and data constructs that provide the functionality of the present invention. Software is stored in storage unit which may include a memory unit and file storage unit. The memory unit may include a main random access memory (RAM) for storage of instructions and data during program execution and a read-only memory (ROM) in which fixed instructions are stored.

The file storage unit of the data storage unit may provide persistent (nonvolatile) storage for program and data files, and typically includes at least one hard disk drive and at least one CD-ROM drive (with associated removable media). There may also be other devices such as a floppy disk drive and optical drives (all with their associated removable media). Additionally, the file storage unit may include drives of the type with removable media cartridges, such as hard disk cartridges and flexible disk cartridges. One or more of the drives may be located at a remote location on a local area network or at a site on the Internet's World Wide Web or the entire system may be a stand-alone software application resident on the user's system.

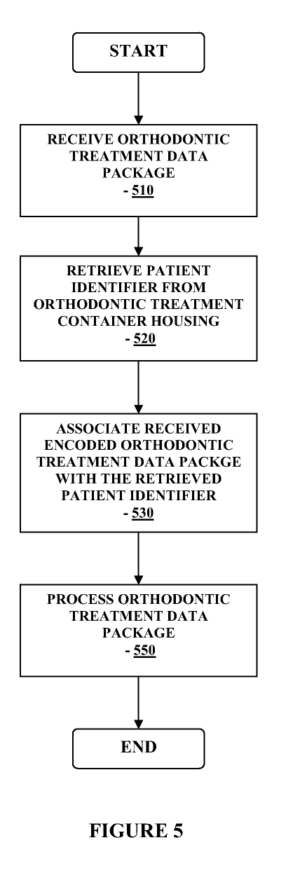

FIG. 5 is a flowchart illustrating efficient orthodontic treatment information management in accordance with yet another embodiment of the present invention. Referring to FIG. 5, at step 510, the orthodontic treatment data package is received. Thereafter at step 520, the patient identifier information is retrieved from the orthodontic treatment container housing. For example, the patient identifier information may be encoded in a bar code label, in which case, a bar code scanner as an input device may be configured to retrieve the patient identifier from the container housing 200.

Referring back to FIG. 5, after retrieving the patient identifier from the orthodontic treatment container housing at step 520, the received encoded orthodontic data package is associated with the retrieved patient identifier at step 530, and further, thereafter, the orthodontic treatment data package for the associated patient is processed to generate, one or more dental appliances associated with the orthodontic treatment. For example, based on the received encoded orthodontic data package for the patient associated with the patient identifier, the treatment data processing site or location 130 may be configured to receive the necessary information for manufacturing the dental appliances for the patient based on the information received from the data acquisition site 140 such as the doctor's office (or via a shipping or transportation site). Moreover, by disposing some or all of the information associated with the patient's orthodontic treatment information, the manufacturing of the dental appliances based on the patient's orthodontic treatment may be readily ascertained from the exterior of the shipping container housing.

Accordingly, a method of orthodontic treatment information management in one embodiment includes generating an orthodontic treatment data package, generating a patient identifier associated with the orthodontic treatment data package, transmitting the generated orthodontic treatment data package to a remote site, encoding the patient identifier, and disposing the encoded patient identifier on a housing of an orthodontic treatment container.

The orthodontic treatment data package may include an orthodontic treatment plan information.

In one embodiment, the orthodontic treatment data package may include one or more of a treatment form, one or more orthodontic image related information, one or more dental impression information, or one or more bite registration information. Furthermore, in another aspect, the one or more orthodontic image related information may include one or more of a graphical image data, a photographic image data, or computer assisted design image data.

In another aspect, the method may also include encoding the orthodontic treatment data package, and also, include encrypting the encoded orthodontic treatment data package.

In one embodiment, encrypting may include using a secure socket layer protocol.

The patient identifier in one embodiment may include encoded using one or more of a bar code, a radio frequency identification (RFID) tag, or an optical identifier.

The patient identifier may be configured to uniquely identify a patient.

The remote site in one aspect may include a manufacturing location for manufacturing one or more dental appliance, where the dental appliance may include one or more of dental aligners or dental retainers.

A method of orthodontic treatment information processing in accordance with another embodiment includes receiving an orthodontic treatment data package, retrieving a patient identifier from a container having one or more orthodontic treatment related material, associating the received orthodontic treatment data package with the retrieved patient identifier, and processing the orthodontic treatment data package for a patient associated with the retrieved patient identifier.

The orthodontic treatment related material may include one or more of a dental impression or a bite registration.

Further, processing the orthodontic treatment data package may include initiating a manufacturing process of a treatment plan using one or more dental appliances.

In another aspect, the received orthodontic treatment data package may include one or more of a treatment form, one or more orthodontic image related information, one or more dental impression information, or one or more bite registration information.

Additionally, the patient identifier may be encoded on a label provided on an exterior of the container using one or more of a bar code, a radio frequency identification (RFID) tag, or an optical identifier.

A system for orthodontic treatment information management in accordance with yet another embodiment includes a communication link, a data acquisition site for generating an orthodontic treatment data package, providing a patient identifier on an exterior of a container housing including one or more orthodontic treatment related material, and transmitting the orthodontic treatment data package over the communication link, and a data processing site for receiving the orthodontic treatment data package over the communication link from the data acquisition site, the data processing site further configured to retrieve the patient identifier from the container housing, and associating the patient identifier with the orthodontic treatment data package.

The data processing site may be further configured to process the orthodontic treatment data package for a patient associated with the retrieved patient identifier.

The communication link in one aspect may include one or more of a local area network connection, a wide area network connection, or an internet connection.

In yet another aspect, the container housing may be transported from the data acquisition site to the data processing site.

Moreover, the patient identifier may be encoded using one or more of a bar code, a radio frequency identification (RFID) tag, or an optical identifier.

An orthodontic treatment shipping container in one embodiment includes a housing, and a label provided on an exterior of the housing, the label including an encoded patient identifier information, where the housing is configured to contain one or more orthodontic treatment material associated with the encoded patient identifier information.

The label in one embodiment may include one or more of a bar coded label, a radio frequency identification (RFID) tag, or an optical identifier.

The housing in one aspect may include a shipping container, and further, wherein the label further includes shipping related information.

In yet another aspect, the one or more orthodontic treatment material may include one or more of bite registration or dental impression.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method of orthodontic treatment information management, comprising:
generating an orthodontic treatment data package;
generating a patient identifier associated with the orthodontic treatment data package;
transmitting the generated orthodontic treatment data package to a remote site;
encoding the patient identifier; and
disposing the encoded patient identifier on a housing of an orthodontic treatment container.

2. The method of claim 1 wherein the orthodontic treatment data package includes an orthodontic treatment plan information.

3. The method of claim 1 wherein the orthodontic treatment data package includes one or more of a treatment form, one or more orthodontic image related information, one or more dental impression information, or one or more bite registration information.

4. The method of claim 3 wherein the one or more orthodontic image related information includes one or more of a graphical image data, a photographic image data, or computer assisted design image data.

5. The method of claim 1 wherein further including encoding the orthodontic treatment data package.

6. The method of claim 5 further including encrypting the encoded orthodontic treatment data package.

7. The method of claim 6 wherein encrypting includes using a secure socket layer protocol.

8. The method of claim 1 wherein the patient identifier is encoded using one or more of a bar code, a radio frequency identification (RFID) tag, or an optical identifier.

9. The method of claim 1 wherein the patient identifier uniquely identifies a patient.

10. The method of claim 1 wherein the remote site includes a manufacturing location for manufacturing one or more dental appliance.

11. The method of claim 10 wherein the dental appliance includes one or more of dental aligners or dental retainers.

12. A method of orthodontic treatment information processing, comprising:
receiving an orthodontic treatment data package;
retrieving a patient identifier from a container having one or more orthodontic treatment related material;
associating the received orthodontic treatment data package with the retrieved patient identifier; and
processing the orthodontic treatment data package for a patient associated with the retrieved patient identifier.

13. The method of claim 12 wherein the orthodontic treatment related material includes one or more of a dental impression or a bite registration.

14. The method of claim 12 wherein the processing the orthodontic treatment data package includes initiating a manufacturing process of a treatment plan using one or more dental appliances.

15. The method of claim 12 wherein the received orthodontic treatment data package includes one or more of a treatment form, one or more orthodontic image related information, one or more dental impression information, or one or more bite registration information.

16. The method of claim 12 wherein the patient identifier is encoded on a label provided on an exterior of the container using one or more of a bar code, a radio frequency identification (RFID) tag, or an optical identifier.

17. The method of claim 12 wherein the patient identifier uniquely identifies a patient.

18. A system for orthodontic treatment information management, comprising:
a communication link;
a data acquisition site for generating an orthodontic treatment data package, providing a patient identifier on an exterior of a container housing including one or more orthodontic treatment related material, and transmitting the orthodontic treatment data package over the communication link; and
a data processing site for receiving the orthodontic treatment data package over the communication link from the data acquisition site, the data processing site further configured to retrieve the patient identifier from the container housing, and associating the patient identifier with the orthodontic treatment data package.

19. The system of claim 18 wherein the data processing site is further configured to process the orthodontic treatment data package for a patient associated with the retrieved patient identifier.

20. The system of claim 18 wherein the communication link includes one or more of a local area network connection, a wide area network connection, or an internet connection.

21. The system of claim 18 wherein the container housing is transported from the data acquisition site to the data processing site.

22. The system of claim 18 wherein the patient identifier is encoded using one or more of a bar code, a radio frequency identification (RFID) tag, or an optical identifier.

23. An orthodontic treatment shipping container, comprising;
a housing; and
a label provided on an exterior of the housing, the label including an encoded patient identifier information;
wherein the housing is configured to contain one or more orthodontic treatment material associated with the encoded patient identifier information.

24. The container of claim 23 wherein the label includes one or more of a bar coded label, a radio frequency identification (RFID) tag, or an optical identifier.

25. The container of claim 23 wherein the housing includes a shipping container, and further, wherein the label further includes shipping related information.

26. The container of claim 23 wherein the one or more orthodontic treatment material includes one or more of bite registration or dental impression.
